(19) United States
(12) Patent Application Publication
(10) Pub. No.: US 2011/0192956 A1
(43) Pub. Date: Aug. 11, 2011

(54) FORMWORK PIN ASSEMBLY

(76) Inventor: Philip T. WARD, Grandview, MO (US)

(21) Appl. No.: 12/702,054

(22) Filed: Feb. 8, 2010

(51) Int. Cl. E04G 17/06; B23P 11/00

(52) U.S. Cl. 249/213; 29/525.01

(57) ABSTRACT

A pin assembly (20) having a substantially automatic locking and stowing mechanism, including a latch (90), a biasing member (70), and an engagement pin (30). The engagement pin includes a hollow-tipped forward end, allowing a hardened core pin insert to be introduced. The latch is operably connected to the pin assembly such that raising the latch compresses, creating an extension force, and tensions, creating a rotational force, the biasing member, and applying a force to the rearward end of the pin assembly causes the extension force to drive the engagement pin forward through aligned openings of the adjacent panels and the rotational force drops the latch securing the two panels in place. The adjacent panels are easily disconnected by raising the latch, compressing, creating an extension force, and tensioning, creating a rotational force, the biasing member, and applying a force to the forward end of the pin assembly causing the extension force to drive the engagement pin back through the aligned openings of the framework panels and the rotational force to drop and stow the latch for later use. A biased catch (75) secures the engagement pin in a retracted position.

### FIELD OF THE INVENTION

The present invention relates to apparatuses and pins for connecting forming panels used in casting cementitious or other materials, such as concrete. More particularly, the present invention concerns pin assemblies utilizing biasing members and hardened core pin inserts.

### BACKGROUND OF THE INVENTION

Formwork is used to contain and shape cementitious or other flowable material, such as concrete, during the pouring and setting, or curing, processes. One common use of formwork is in the casting of walls. Once the material has sufficiently set, the formwork is stripped, or struck, therefrom to be reused elsewhere.

Generally, formwork comprises parallel, spaced apart rows of forming panels, with each panel of a row being temporarily connected to an adjacent panel to define a side of the structure being cast. Various mechanisms have been used to accomplish the connection of adjacent forming panels, including complimentary nuts and bolts and complimentary pins and wedges. Unfortunately, these mechanisms generally suffer from a number of problems and disadvantages, including frequent loss of loose pieces and longer time and increased labor costs associated with engaging and disengaging the mechanisms in order to erect and strip the framework.

One such mechanism comprises a retractable pin and latch. When it is desired to connect adjacent panels, the retracted pin associated with a first panel is extended through a corresponding hole in the second panel. Often this is accomplished by striking the opposite end of the pin with a hammer to drive it through the at least partially aligned hole. Even in some of the most advanced apparatuses, momentum prevents the latch from properly securing the panels and the worker must manually engage the latch, with one side fitting snugly around the inside adjacent edges of both the first and second panels to prevent the inadvertent retraction of the pin and disconnection of the panels. Another step is required to move the lock into a latched position. When it is desired to disconnect adjacent panels, the engaged latch is first manually disengaged, i.e., pried up and above the inside edges of both the first and second panels to provide sufficient clearance; the pin is retracted from the corresponding hole by striking the end of the pin with a hammer. Because the pin is not connected to a housing structure, the pin occasionally bounces back and multiple strikes are required. Another problem that results from a lack of attachment to the housing structure is the pin often falls out of place and is easily lost. Because the pins must be longer within the housing to avoid this issue, the latch often does not travel far enough to properly secure the panels. This is also an issue when it is desired to retract the pin and stow the latch because the pin often does not retract all the way through the openings, or bounces back requiring several strikes. Also, these types of assemblies often do not allow the engagement pin to travel back through both panels and the worker must rotate the panels apart to effectively strip the framework. Finally, the latch is manually stowed by rotating the latch towards the now poured cementitious or other flowable material. It will be appreciated that this process requires several steps and wastes significant labor time by requiring multiple strikes and time spent looking for missing pieces of the assembly. In these and other devices, it has been generally viewed as an disadvantage to use elongated pins, or pins with increased tapering of the forward end, for initially securing the panels, both due to cost and increased mushrooming of the tip of the engagement pin. Although these assemblies are often described as one-step mechanisms, in actual use, these mechanisms often involve many additional steps, as described above, to accomplish the same goals as the present invention.

### SUMMARY OF THE INVENTION

The present invention overcomes the above-discussed and other problems and disadvantages by providing an improved pin assembly having a biasing member and a latch to automatically secure the first and second panels and to ease disassembly of the formwork by automatically stowing the latch.

The present invention also overcomes the above-discussed and other problems and disadvantages by providing a hardened core pin insert that couples to an engagement pin to allow for the latch to travel the appropriate distance to secure the engagement panels and also prevents mushrooming of the tip of the engagement pin.

The present invention also overcomes the above-discussed and other problems and disadvantages by providing, in one embodiment, a biased catch that secures the engagement pin in a retracted position, allowing for disassembly with a single tool. The biased catch allows use of a shorter engagement pin, because the biased catch prevents problems associated with bounce back of the engagement pin.

In one embodiment, the pin apparatus comprises an engagement pin including a latch such that raising the latch compresses, creating an extension force, and tensions, creating a rotational force, the biasing member and a first force applied to the pin assembly releases the extension force in the biasing member driving the engagement pin through aligned openings in the panels, the rotational force dropping the latch and securing the panels to be locked into place. When the panels are ready for disassembly, raising the latch compresses, creating a retraction force, and tensions, creating a rotational force, the biasing member and a second force applied to the pin assembly releases the retraction force in the biasing member, driving the engagement pin back through the aligned openings in the panels, the rotational force dropping the latch into a stowed position.

In various implementations, the pin apparatus includes any one or more of the following additional features. The biasing member is a torsion spring to allow kinetic energy stored in the biasing member to extend or retract the engagement pin and to force the latch from a raised position to a secured or stowed position.

In one embodiment, the biasing member has a posterior tail coupled to a hole in the posterior of the housing. The biasing member, in this particular embodiment, also has an anterior tail, coupled to a groove in the engagement pin or an o-ring, in another embodiment, acting as a retaining clip coupled to the engagement pin.

In another embodiment, the biasing member has a small section and a large section, the small section fitting into a grease groove in the housing whereby raising the latch tensions the biasing member, such that the small section coils expand providing frictional engagement with the interior of the housing, locking the biasing member into a pre-loaded position. In this embodiment, the biasing member is secured by friction and there is no need for a hole in the posterior of the housing to hold the biasing member into place. The groove also facilitates the rotational movement, allowing the latch to move into a stowed or secured position.

The apparatus may include a hollow-tipped engagement pin to allow a hardened core pin insert to be introduced, coupled in one embodiment, into the hollow-tipped end of the engagement pin. In one embodiment, the additional length allows the front edge of the latch to travel beyond the edge of both panels so it snaps down securing the panels and preventing the engagement pin from moving out of place.

In one embodiment, a hollowed-out section of the horizontal axis of the engagement pin is included to allow introduction of a wedge.

The apparatus may further include an o-ring, coupled in one embodiment to a groove in the tail of the engagement pin, wherein the o-ring functions as a retainer clip to hold the rearward end of the engagement pin in the housing of the assembly. In one embodiment, the o-ring is steel so that when coupled with the engagement pin the two are locked in place and cannot come apart. This enables the engagement pin to maintain its ability to rotate, without falling out of place.

The apparatus may rely on the biasing member, in one embodiment, rather than an o-ring, to prevent the latch from falling out of the pre-loaded position until it is desired to attach or disassemble the panels.

In one embodiment, a biased catch within the housing is biased by the engagement pin on one end, and attachable to the housing on the opposing end. The biased catch holds the engagement pin in place with friction in the retracted position.

These and other features of the present invention are described in greater detail below in the section titled DETAILED DESCRIPTION.

### BRIEF DESCRIPTION OF THE DRAWING FIGURES

The present invention is described herein with reference to the following drawing figures, with greater emphasis being placed on clarity rather than scale:

FIG. 1 is a plan view showing one embodiment of a latch securing two panels;

FIG. 2 is an exploded view showing one embodiment of the formwork pin assembly;

FIG. 3 is a plan view of one embodiment with the panels unsecured and the latch pre-loaded;

FIG. 4 is a plan view of one embodiment with the panels secured and the latch pre-loaded;

FIG. 5 is a plan view of one embodiment of two adjacent panels secured in one embodiment of the invention;

FIG. 6 is an elevation view of one embodiment of a hollow-tipped engagement pin with insert and retrofitted for use with a wedge;

FIG. 7 is an isometric view of one embodiment of an engagement pin retrofitted for use with a wedge, a hollow-tipped end for use with an insert, and a wedge; and

FIG. 8 is a plan view of one embodiment of a biasing member with a small section and a large section.

### DETAILED DESCRIPTION

With reference to the drawing figures, a pin assembly 20, a latch 90, a biasing member 70, and an engagement pin 30 are herein described, shown, and otherwise disclosed in accordance with one or more embodiments, including one or more preferred embodiments, of the present invention.

More particularly, the present invention concerns a pin assembly 20 having a substantially automatic locking and stowing mechanism, including a biasing member 70, a latch 90, and an engagement pin 30.

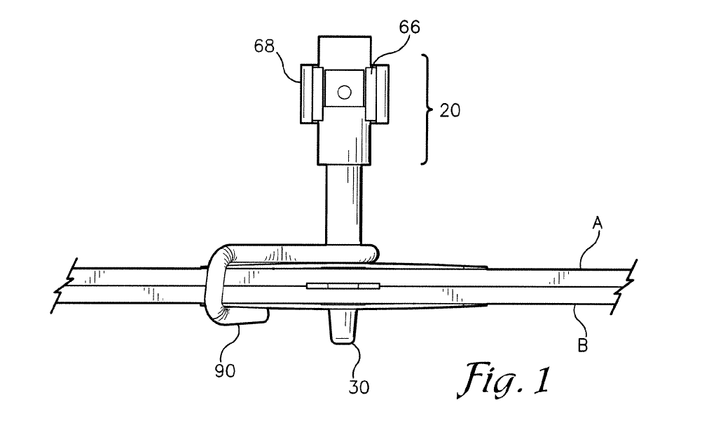

Referring particularly to FIG. 1, the pin assembly 20 has application in temporarily connecting adjacent forming panels A,B of formwork used in casting cementitious or other material, such as concrete. Broadly characterized, the pin assembly 20 has a substantially automatic locking and stowing mechanism which requires fewer steps and, therefore, less time to erect and strip (disassemble or disconnect) the forming panels A,B.

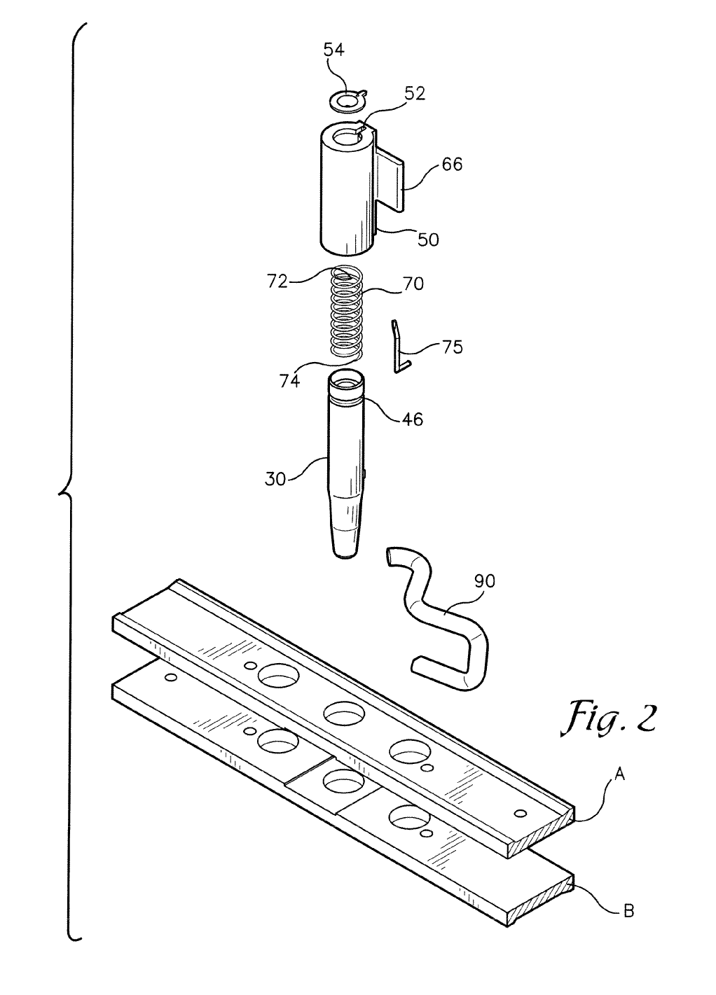

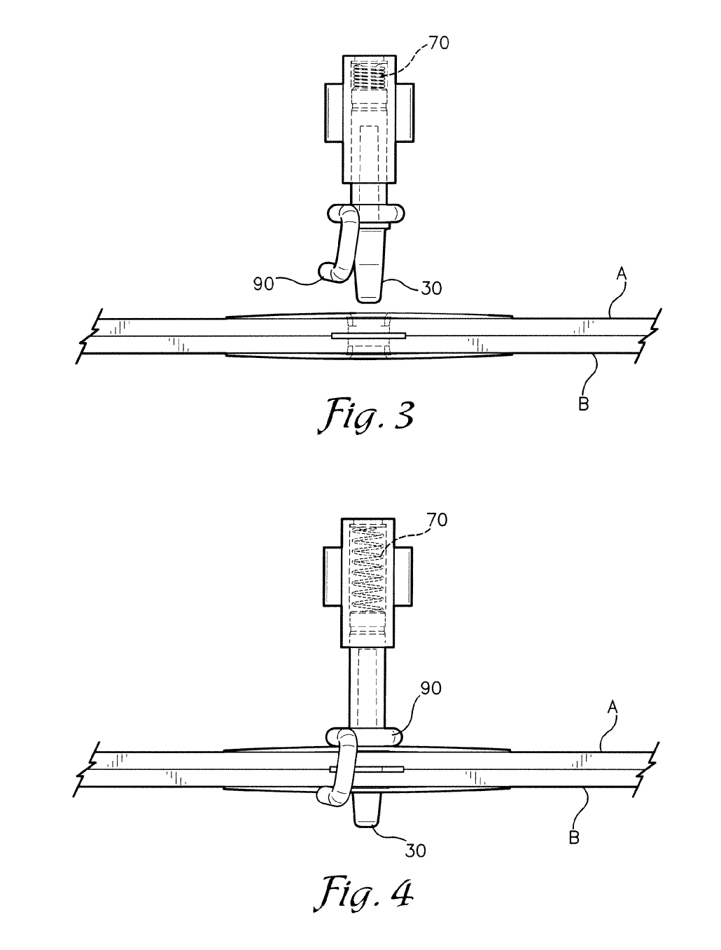

More specifically, referring also to FIG. 2, the pin assembly 20 comprises an engagement pin 30, a latch 90, and a biasing member 70 coupled, in one embodiment, on the rearward end to a housing 50 and on the forward end to the rearward end of the engagement pin. When it is desired to connect the forming panels A,B, the panels A,B, are positioned such that the engagement pin is at least partially aligned with an opening in the adjacent panel, the latch is raised, see FIG. 3, compressing, creating an extension force, and tensioning, creating a rotational force, in the biasing member, and the rearward end of the pin assembly is struck, such as with a hammer, the extension force in the biasing member driving the engagement pin through the openings in the panels, the rotational force in the biasing member causing the latch to drop, thereby substantially automatically securing the forming panels A,B together.

Thereafter, referring also to FIG. 4, when it is desired to disassemble or disconnect the forming panels A,B, the latch 90 is raised, compressing, creating a retraction force, and tensioning, creating a rotational force, the biasing member 70, the forward end of the engagement pin 30 is struck, such as with a hammer, the retraction force in the biasing member driving the engagement pin back through the openings in the panels, the rotational force in the biasing member causing the latch to drop, thereby substantially automatically stowing the latch.

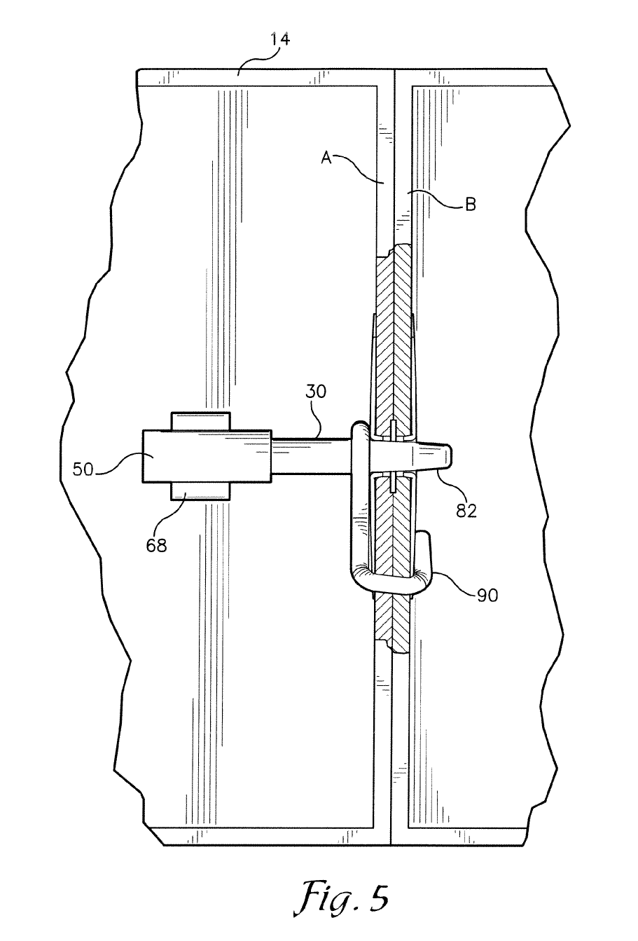

Referring particularly to FIG. 5 (need other figures here), the apparatus 10 may comprise a pin assembly 20 and a mounting structure 14. The pin assembly 20 may include a housing 50, an engagement pin 30, a biasing member 70, and a latch 90. Broadly, the mounting structure 14 is operable to removably retain the pin assembly 20 on the first forming panel A, and the pin assembly 20 is operable to extend and retract in such a manner as to releasably engage the adjacent second forming panel B.

The mounting structure 14 supports the pin assembly 20 in its operating positions, i.e., both its locked and unlocked positions. The mounting structure 14 may include a five-sided box, i.e., four sidewalls and a bottom, and the receiver 68. The receiver 68 may be affixed to the bottom of the mounting box and slidably receives the flanges 66 of the mounting plate 42 of the housing 50 of the pin mechanism 12. There may be a plurality of such receivers, or at least one receiver with a plurality of positions for receiving the pin mechanism 12. The sidewalls adjacent and opposite the receiver present at least one opening through which the engagement pin 30 extends and retracts. Where there are a plurality of receivers or multiple positions for receiving the pin mechanism 12, there are multiple corresponding openings in the sidewalls for the engagement pin 30. The other sidewalls may also each present at least one such opening for engagement pins.

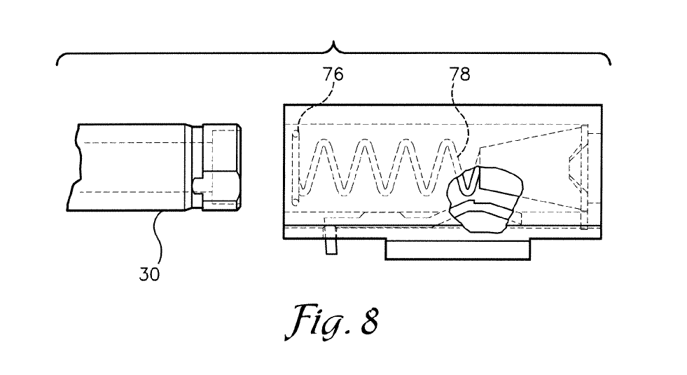

The biasing member 70 is operable to bias the engagement pin 30 and latch 90 in a normally forward direction relative to the housing 50 and the mounting structure 14. Referring to FIG. 8, in one embodiment, the biasing member 70 has a small section 72 and a large section 74, the small section fitting into a grease groove in the housing whereby raising the latch tensions the biasing member, such that the small section coils expand providing frictional engagement with the interior of the housing, locking the biasing member into a pre-loaded position. In this embodiment, the biasing member is secured by friction and there is no need to for a hole in the posterior of the housing to hold the biasing member into place. The groove also facilitates the rotational movement, allowing the latch to move into a stowed or secured position.

The pin assembly 20 is operable to physically engage and disengage an adjacent forming panel, tie, or other structure. Referring particularly to FIG. 5, the pin assembly 26 includes the engagement pin 30 and the latch 90. The engagement pin 30 is operable to slidably engage and disengage the second panel B. The engagement pin 30 may be substantially elongated. The head end 82 may be tapered, e.g., substantially frustoconical, in shape in order to facilitate clearing the head end 82 when it desired to separate the panels A,B.

Referring particularly to FIG. 2, a plate (not shown) in the rearward end of the housing has a hole suitably designed, in one embodiment, to receive a rearward tail 42 of the biasing member 70. The biasing member also has a forward tail 44, in another embodiment, coupled to a groove 46 in the engagement pin. In this embodiment, an o-ring may act as a retainer clip to hold the rearward end of the engagement pin in the housing to prevent the pin assembly from falling apart. In a preferred embodiment, the o-ring is coupled to the engagement pin by cutting a groove in the rearward end of the engagement pin. In one embodiment, the o-ring is made of steel so that the o-ring and engagement pin are locked into place.

The pin assembly 20 is designed, in one embodiment, without the need for a second o-ring preventing the latch from falling out of place. Instead, the assembly relies on the biasing member 70 to prevent the latch from falling out of place.

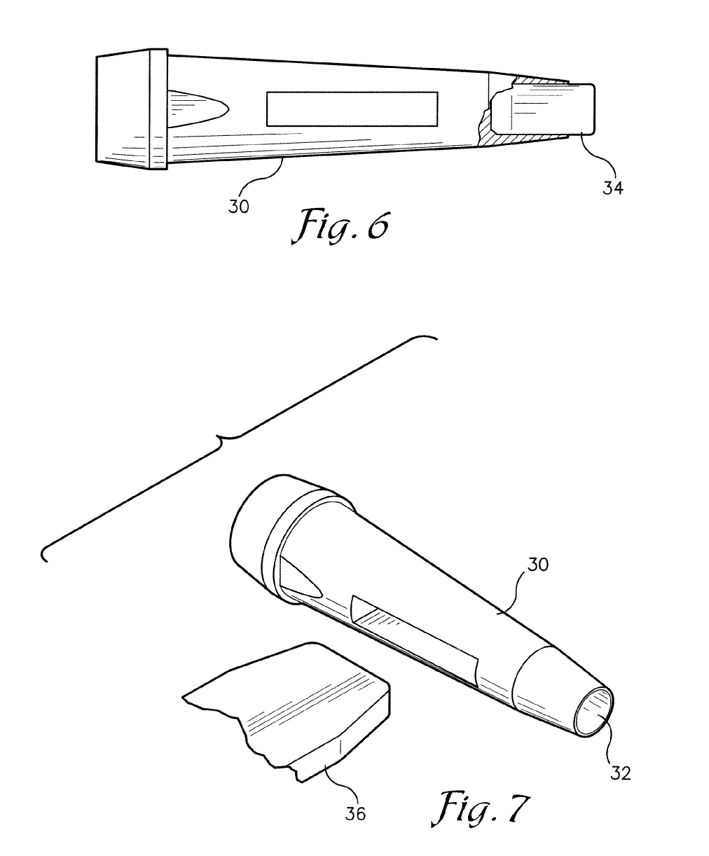

Referring to FIGS. 6 and 7, the engagement pin 30 is, in one embodiment, hollow-tipped 32 such that a hardened core pin insert 34 is introduced. In a preferred embodiment, the hardened core pin insert is coupled to the hollow-tipped end of the engagement pin. The resulting elongated pin is viewed by those reasonably skilled in the art as a disadvantage due to increased mushrooming and cost. However, the addition of the pin insert solves the long-felt, but unresolved problem of mushrooming of the pin. In actual tests, the pin insert, after two thousand cycles, approximately equal to ten years of use, displays no signs of mushrooming. By contrast and also in actual tests, the standard engagement pin without a pin insert, displays significant signs of mushrooming after only two hundred cycles, or approximately one year of use. Although it is recognized that increased tapering of the forward end of the engagement end coupled with the forces exerted by the cementitious material held in place by the formwork assists with the retracting of the engagement pin, however those skilled in the art are not able to utilize increased tapering in actual practice, because mushrooming of the tip is greatly exaggerated by increased tapering. The additional length also allows the latch 90 to travel the appropriate distance to properly secure the forming panels A, B.

In another embodiment, the engagement pin includes a hollowed-out section along its horizontal axis, as seen in FIG. 7, to allow a wedge 36 to be introduced to the apparatus. Wedges are known to those reasonably skilled in the art to help secure and prevent the engagement pin from inadvertent retraction.

In another embodiment, a biased catch 75, within the housing is biased by the engagement pin on one end and attachable to the housing on the opposing end. In one embodiment, the biased catch is made of spring steel. When it is desired to unlock the first and second forming panels A,B, the latch 90 is struck, such as with a hammer, and the forward end of the engagement pin 30 is struck, again with a hammer, driving the engagement pin back through the openings in the panels and unlocking the panels, whereby the biased catch holds the engagement pin in place with friction, preventing the engagement pin from backing out. In this embodiment, there is no need for the biasing member to be in torsion. Thus, the biased catch allows for disassembly with a single tool, whereas previous formwork assemblies require the use of a hammer to knock down the clamp and a screwdriver to pry the clamp back. Actual tests have shown that by utilizing the biased catch, the formwork can be stripped approximately twice as fast as the previous formwork assemblies because a single tool can be used and because the biased catch prevents the engagement pin from bouncing back, a common problem with previous formwork assemblies that necessitates multiple strikes with a hammer.

In exemplary use and operation, the apparatus 10 of the present invention may be used and function substantially as follows. Referring again to FIG. 5, the mounting structure 14 is initially coupled to the first forming panel A and the pin assembly 20 is coupled with the mounting structure 14, the engagement pin 30 is in its fully retracted position, i.e., and the latch 90 is fully raised, compressing the biasing member 70, creating an extension force, and tensioning the biasing member, creating a rotational force as seen in FIG. 3. The first panel A is positioned such that the opening in the mounting structure 14 through which the engagement pin 30 will extend is aligned with a corresponding opening in the second panel B. When it is desired to lock the first and second forming panels A,B together, the rearward end of the pin assembly 20 is struck, such as with a hammer, the extension force in the biasing member driving the engagement pin through the openings in the panels, whereby the rotational force in the biasing member causes the latch to drop, thereby securing the forming panels A,B. At this point, the first and second forming panels A,B are now secured, as seen in FIGS. 1 and 5. This process is repeated for each pair of adjacent forming panels until the framework is fully assembled.

When it is desired to unlock the first and second forming panels A,B, the latch 90 is raised, as seen in FIG. 4, compressing the biasing member 70, creating a retracting force, and tensioning the biasing member, creating a rotational force, the forward end of the engagement pin 30 is struck such as with a hammer, the retraction force in the biasing member driving the engagement pin back through the openings in the panels, disconnecting the panels, whereby the rotational force in the biasing member causes the latch to drop, thereby substantially automatically stowing the latch. At this point, the first and second forming panels A,B are disconnected. This process is repeated for each pair of adjacent forming panels until the framework is fully disassembled.

In one application, the pin assembly 20 is provided by itself, i.e., separate from any mounting structure 14, so that it can be used, as desired, to make spot connections at particular points on the panels A,B, such as at the bottom of the formwork where pressures due to the weight of the poured material are greatest.

Although the invention has been disclosed with reference to various particular embodiments, versions, and implementations, it is understood that equivalents may be employed and substitutions made herein without departing from the scope of the invention as recited in the claims.

Having thus described the preferred embodiment of the invention, what is claimed as new and desired to be protected by Letters Patent includes the following:

1. An apparatus for connecting adjacent panels having aligned openings, the apparatus comprising a pin assembly including an engagement pin and a biasing member, wherein an extension force operable to release the biasing member driving the engagement pin through the aligned openings in the adjacent panels, a rotational force in the biasing member causing a latch to lock the adjacent panels together.

2. The apparatus set forth in claim 1, wherein a retraction force operable to release the biasing member driving the engagement pin substantially back through the aligned openings in the adjacent panels, and a locking force in the biasing member stowing the latch.

3. The apparatus as set forth in claim 1, wherein the engagement pin has a hollow-tipped forward end.

4. The engagement pin set forth in claim 3, wherein a pin insert is coupled to the hollow-tipped forward end of the engagement pin.

5. The apparatus as set forth in claim 1, wherein the engagement pin is coupled to a housing structure.

6. The apparatus as set forth in claim 5, wherein the rearward end of the biasing member couples to the housing structure and the forward end of the biasing member couples to the engagement pin.

7. The apparatus as set forth in claim 1, wherein the biasing member is a torsion spring.

8. The apparatus as set forth in claim 1, wherein raising the latch compresses and tensions the biasing member.

9. The apparatus as set forth in claim 1, wherein the rearward end of the engagement pin is coupled to the housing by an o-ring.

10. The apparatus as set forth in claim 1 further comprising a wedge for securing and preventing inadvertent retraction of the engagement pin.

11. An apparatus for connecting adjacent panels, the apparatus comprising:
a housing;
an engagement pin within the housing;
a latch; and
a biasing member operable to drive the engagement pin through substantially aligned openings in the panels and drop the latch to secure the panels.

12. A method of connecting adjacent panels of a formwork which comprises:
(a) raising a latch compressing and building extension and rotational forces in a biasing member; and
(b) applying a force to the rearward end of a pin assembly, the extension force driving an engagement pin through substantially aligned openings of the adjacent panels, the rotational force dropping the latch and securing the adjacent panels.

13. The method as set forth in claim 12 wherein the engagement pin has a hollow-tipped front end.

14. The method as set forth in claim 13 wherein a pin is coupled to the hollow-tipped front end of the engagement pin.

15. A method of disconnecting adjacent panels of a formwork which comprises:
(a) raising a latch compressing and building retraction and rotational forces in a biasing member; and
(b) applying a force to the forward end of a pin assembly, the retraction force driving an engagement pin back through substantially aligned openings of the adjacent panels, the rotational force dropping the latch into a stowed position.

16. The method as set forth in claim 15 wherein the engagement pin has a hollow-tipped front end.

17. The method as set forth in claim 16 wherein a pin is coupled to the hollow-tipped front end of the engagement pin.

18. An apparatus for connecting adjacent panels having aligned openings, the apparatus comprising a pin assembly including an engagement pin, a biasing member, and a biased catch, wherein applying a force drives the engagement pin through the aligned openings in the adjacent panels, the biased catch applying a frictional force securing the engagement pin and causing the adjacent panels to remain locked together.

19. An apparatus for connecting adjacent panels, the apparatus comprising:
a housing;
an engagement pin within the housing;
a latch;
and a biased catch operable to secure the engagement pin in a retracted position within the housing.

20. A method of disconnecting adjacent panels of a formwork which comprises:
(a) raising a latch; and
(b) applying a retraction force to the forward end of a pin assembly, the retraction force driving an engagement pin back through substantially aligned openings of the adjacent panels, a biased catch securing the engagement pin in a retracted position.
